(19) United States
(12) Patent Application Publication
(10) Pub. No.: US 2012/0265606 A1
(43) Pub. Date: Oct. 18, 2012

(54) SYSTEM AND METHOD FOR OBTAINING CONSUMER INFORMATION

(76) Inventor: Michael L. Patnode, San Francisco, CA (US)

(21) Appl. No.: 13/447,985

(22) Filed: Apr. 16, 2012

Related U.S. Application Data
(60) Provisional application No. 61/475,668, filed on Apr. 14, 2011.

(51) Int. Cl. G06Q 30/02

(52) U.S. Cl. 705/14.41

(57) ABSTRACT

A system and method for obtaining consumer information from an advertising display computer (ADC) located at a plurality of advertising locations is disclosed. In one example, the method comprises the acts of displaying a plurality of advertisements on the ADC, capturing at least one image at the plurality of advertising locations, the at least one image including an image of at least one person, determining at least one impression from the image of at least one person, detecting facial recognition information from the image associated with the at least one impression, storing impression information and the facial recognition information associated with the at least one impression, and associating the impression information and the facial recognition information with one of the plurality of advertisements displayed on the ADC.

### RELATED APPLICATIONS

This application claims priority under 35 U.S.C. §119(e) to U.S. Provisional Application Ser. No. 61/475,668 entitled “SYSTEM AND METHOD FOR OBTAINING CONSUMER INFORMATION,” filed on Apr. 14, 2011, which is hereby incorporated herein by reference in its entirety.

### BACKGROUND

1. Applicable Field

The field of the present invention relates generally to systems and methods for obtaining consumer information.

2. Related Art

Advertisers frequently employ computer displays for advertisements to attract consumer attention and better influence consumer purchasing decisions. Typical computer advertising displays present advertising content on indoor and outdoor display screens, which are generally placed in high traffic locations where people are likely to view advertisements that are displayed on such screens. Advertisers purchase advertising space from computer display providers who organize the advertising content, typically showing the advertisements sequentially.

### SUMMARY

Generally, advertisers seeking advertising space can only speculate on the impact of advertising on the consumer's decision to purchase. According to one aspect of the present invention, it is appreciated that feedback from people viewing computer advertising would be beneficial to determining the effects of advertising on consumers. Gaining greater knowledge about consumer interests at early stages of the purchasing cycle can help the advertiser to better target the consumer's interests and increase the likelihood of impacting the purchasing decision.

Aspects and embodiments of the present invention are directed to consumer impression detection systems and methods that obtain consumer impressions. In one embodiment, the system determines whether a person is looking at the advertising display and registers that event as an impression. The consumer impression detection system using facial recognition systems and methods analyses facial information pertaining to the person. The system may then generate statistical data based on the recorded impressions and the facial information about each person.

According to one embodiment, a computer-implemented method of obtaining consumer information from an advertising display computer (ADC) located at a plurality of advertising locations is disclosed. The method comprises the acts of displaying a plurality of advertisements on the ADC, capturing at least one image at the plurality of advertising locations, the at least one image including an image of at least one person, and determining at least one impression from the image of at least one person. The method further including the acts of detecting facial recognition information from the image associated with the at least one impression, storing impression information and the facial recognition information associated with the at least one impression, and associating the impression information and the facial recognition information with one of the plurality of advertisements displayed on the ADC.

In the method, the act of determining the impression may further comprise determining whether the at least one person is looking at the advertising display computer. In addition, the act of detecting the facial information may further comprise detecting a unique set of facial features of the at least one person. In some embodiments, the act of detecting the facial information further comprises detecting at least one emotional expression of the at least one person.

In at least one embodiment, detecting the facial information about the at least one person further comprises matching the facial recognition information of the at least one person to a database of facial recognition information. In addition, the act of determining at least one impression from the image of at least one person may further comprise assigning an identification value to the at least impression.

The method may further comprise producing facial recognition and impression statistics generated from the at least one impression and the facial information. In one embodiment, associating the at least one impression and the facial recognition information with one of the plurality of advertisements further comprises storing a first timestamp value for the plurality of advertisements, wherein the timestamp value includes a time associated with display of an advertisement on the ADC. In addition, associating the at least one impression and the facial recognition information with one of the plurality of advertisements may further comprise storing a second timestamp value for the at least one impression, wherein the timestamp value includes a time associated with a determination that the at least one person is looking at the ADC. The method may further comprise the act of comparing the first timestamp value with the second timestamp value to associate the at least one impression, the impression information and the facial recognition information with the at least one advertisement.

According to another embodiment, a system for obtaining consumer information at a plurality of advertising locations is disclosed. The system comprising an advertising display computer (ADC) located at the plurality of advertising locations configured to display at least one advertisement, and a camera disposed to capture at least one image of each of the plurality of advertising locations, the at least one image including an image of at least one person. In addition, the system comprises a processor configured to determine at least one impression from the image of at least one person, detect facial information from the image associated with the at least one impression, and associate the at least one advertisement displayed on the ADC with the at least one impression and the facial information. Further, the system comprises an impression database configured to store impression information and the facial information associated with the at least one impression.

In one embodiment, the at least one impression comprises detection of the at least one person looking at the at least one advertisement on the ADC. According to another embodiment, the impression database is configured to store an identification value for each impression based on the at least one person. In addition, the processor may further include a recognition engine adapted to determine at least one emotion associated with the at least one person.

Further, the processor may be configured to record a timestamp value for the at least one advertisement displayed on the advertising display. In one embodiment, the processor is configured to determine a timestamp value for the at least one impression. The processor may be further configured to associated the timestamp value for the at least one advertisement of with the timestamp value for the at least one impression.

According to another embodiment, a system obtaining consumer information at a plurality of advertising locations is disclosed. The system comprises a media scheduling server configured to determine a schedule including at least one advertisement at an advertising display computer (ADC) at each of the plurality of advertising locations, and a communication device configured to transmit the at least one advertisement to the ADC and receive advertisement display information, impression information and facial recognition information associated with at least one impression from the ADC at each of the plurality of advertising locations. The system may further include a reporting engine configured to process the advertisement display information, the impression information and the facial recognition information and a user interface configured to display the processed advertisement display information, the impression information and the facial recognition information.

In one embodiment, the at least one impression comprises detection of the at least one person looking at the at least one advertisement on the ADC and the impression information comprises an identification value for the at least one impression associated with the at least one person. In at least one embodiment, the processor is configured to determine a first timestamp value for the at least one advertisement displayed on the advertising display and a second timestamp value for the at least one impression and associate the first timestamp value with the second timestamp value.

According to another embodiment, a non-transitory, non-volatile, computer readable medium having computer readable instructions stored thereon, as a result of being executed by a computer, instruct the computer to perform a method of displaying a plurality of advertisements on an advertising display computer (ADC) located at a plurality of advertising locations, capturing at least one image at the plurality of advertising locations, the at least one image including an image of at least one person, determining at least one impression from the image of at least one person, detecting facial recognition information from the image associated with the at least one impression, storing impression information and the facial recognition information associated with the at least one impression, and associating the impression information and the facial recognition information with one of the plurality of advertisements displayed on the ADC.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Further features and advantages as well as the structure and operation of various embodiments are described in detail below with reference to the accompanying drawings. In the drawings, like reference numerals indicate like or functionally similar elements. Additionally, the left-most one or two digits of a reference numeral identifies the drawing in which the reference numeral first appears.

FIG. 1 is a block diagram of one example of a system of displaying advertisements, according to embodiment and aspects of the present invention;

FIG. 2 is a flow diagram illustrating one example of a method of displaying advertisements, according to embodiments and aspects of the present invention; and

FIG. 3 is a block diagram of one example of a system of displaying advertisements, according to embodiment and aspects of the present invention.

### DESCRIPTION

As described above, receiving feedback from people viewing computer advertising may help advertisers determine the impact the advertising on the consumer purchasing decisions. Accordingly, there is a need for systems and methods for detection of consumer impressions. As used herein, the term “impression” or “consumer impression” may refer to consumer interest in a particular advertisement. The consumer impression may be detected whether the consumer's attention is drawn to the advertisement on the advertising computer display. Such systems and methods can allow the advertiser to better target specific audiences of consumers and to assist in delivering promotional messages at the right time and place.

Aspects disclosed herein, which are in accordance with various embodiments of the present invention, are not limited in their application to the details of construction and the arrangement of components set forth in the following description or illustrated in the drawings. These aspects are capable of assuming other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

For example, according to various embodiments of the present invention, a computer system is configured to perform any of the functions described herein, including but not limited to, performing one or more image processing and analysis functions. However, such a system may also perform other functions. Moreover, the systems described herein may be configured to include or exclude any of the functions discussed herein. Thus the embodiments of the invention are not limited to a specific function or set of functions. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

According to one embodiment of the invention, an advertising display computer (ADC) displays a number of advertisements to customers who are located near the display at an advertising location. The advertisements may be transmitted from the central server and stored on the ADC. The central server receives uploaded advertisements from advertisers, determines the format of the advertisement for display on the ADC and creates a line up of advertisements for each ADC at each advertising location. The ADC may record and store display information pertaining to the advertisements previously shown on the ADC and transmit that display information to the central server.

In one embodiment, the ADC includes a camera that obtains images of consumers located near the display. The ADC may obtain a consumer impression by detecting whether a consumer is looking at the display. In one embodiment, in response to obtaining the impression, the ADC uses image processing to detect, extract and store an image of the person's face. By using facial recognition systems and methods, the ADC may analyze facial information pertaining to the person from the image and store the detected facial information in memory along with the image. The image and the facial information may be correlated to advertisement display information and used to generate impression statistics for each advertiser.

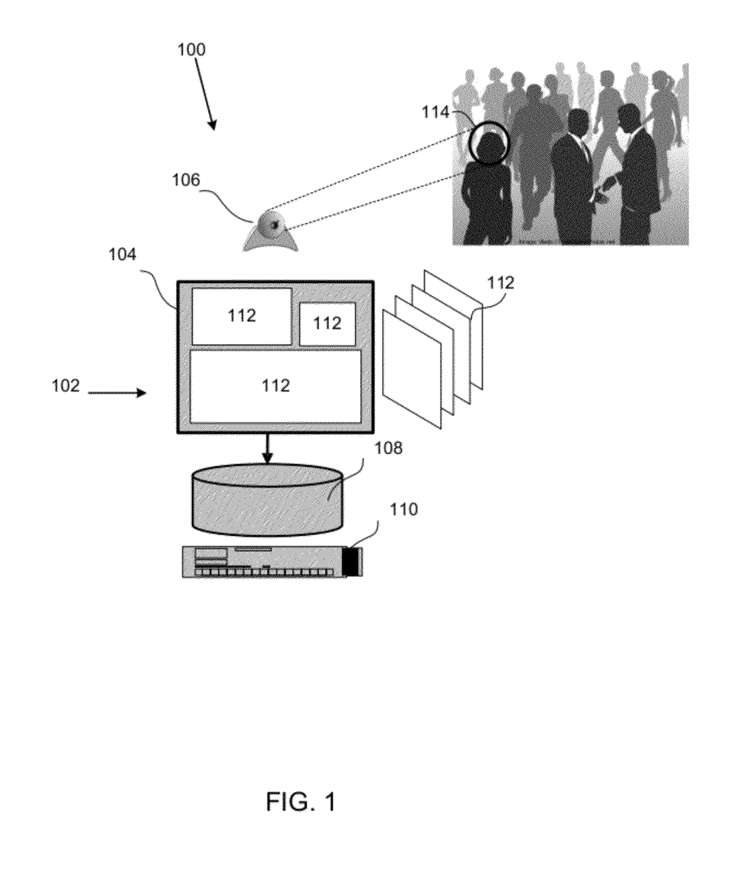

FIG. 1 shows a system of displaying advertising 100, in which various aspects and functions according to embodiments of the present invention may be practiced. For example, as illustrated, the system includes an advertising display computer (ADC) 102, which comprises a display screen 104, a camera 106, local storage media 108, and a CPU 110. Although only one ADC 102 is shown, the system 100 may include any number of ADCs that may be placed at any number of geographic locations.

In one embodiment, the ADC 102 is located at an advertising location, which may be any type of establishment where there is a frequent flow of customers. For example, the ADC 102 may be placed in a commercial location such as a convenience store, a supermarket, a pharmacy, or a gas station or any other type of commercial establishment. In one embodiment, the ADC 102 may be implemented as a single integrated system. Alternatively, the ADC 102 may be implemented as separate components, for example, as a separate control unit and display screen. Further, the control unit may be plugged into a display screen already present at the commercial location. The ADC 102 may be hung on a wall or suspended from the ceiling at the commercial location. In another embodiment, the ADC 102 may be self-standing system, such as a kiosk.

In one embodiment, the display screen 104 sequentially shows a number of advertisements 112 to customers who are located near the display. Any type of display may be utilized, including, but not limited to, a Cathode Ray Tube (CRT), a Liquid Crystal Display (LCD), a Plasma Display or a Light Emitting Diode (LED) Display. The advertisements may contain graphics, text, animation, video, audio or any combinations thereof and may be implemented using any multimedia platform. For example, platforms including, but not limited to, flash, such as SWF, SVG and SMIL, as well as interactive visualizations, including HTML 5 and JAVA, video streaming, including Microsoft Silverlight, and video formats, including AVI, WMV, MPEG-4 or any other platform.

Each advertisement 112 may be displayed for a predetermined period of time. For example, the advertisement 112 is displayed for 15 seconds, 30 seconds, 1 minute, or any other length of time. The advertisements 112 may be shown one at a time and occupy the entire display screen. Alternatively, one or more of the advertisements may be shown concurrently taking up different portions of the display screen 104.

The display screen 104 may be a touch screen system that receives input from customers through a touch or selection of areas of the screen (referred to as hot-zones). Once a hot-zone is pressed by a customer, new content may appear on the display screen using the same or different multimedia platform. The interaction with the screen may be processed by the CPU 110 and stored onto the local media storage 108.

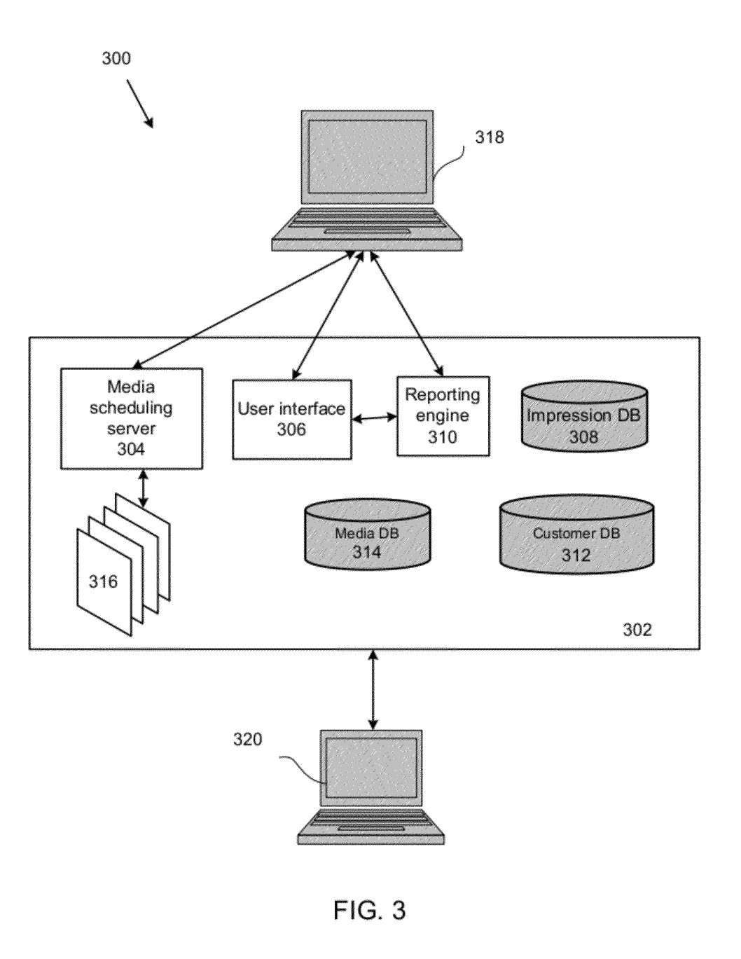

In one embodiment, the advertisements 112 shown on the display screen 104 are transmitted from the central server 302 (shown in FIG. 3) and stored on the local media storage 108. In addition to the advertisements 112, control information for displaying the advertisements may also be transmitted from the central server 302 and stored on the local media storage 108. For example, the instructions may include the period of time for displaying each advertisement 112, the location of the advertisement on the display screen, the size of the advertisement 112 in proportion to the screen, and the sequence of advertisements and/or other content.

In one embodiment, the ADC 102 includes a camera 106 that records images 114 of consumers in the advertising location. These recorded images 114 may be translated into consumer impressions by using systems and methods of facial recognition. The camera 106 may be configured to capture images or video footage of the advertisement location, and accordingly may include one or more imaging sensors along with control apparatus for managing various functions of the camera. The camera 106 may also include executable programming used to manage and control various functions of the camera 106.

A variety of different cameras may be used, including, for example, a web camera that takes video footage of the advertising location. In another example, the camera 106 may capture a high resolution video recording and compress the video recording to a smaller size using an encoder. In another embodiment, a still-frame digital photo camera, such as a digital point-and-shoot camera may be included. The camera 106 may be disposed to take panoramic or 360 degree images of the scene. In one example, the camera 106 is configured to take continuous pictures of the scene and direct the images for processing by the CPU 110. The camera 106 may also use other sensors/equipment to improve consumer impression detection under difficult lighting conditions.

In one embodiment, facial recognition systems and methods may be used on the images obtained by the camera 106, and include the steps of detection, alignment, measurement, representation, and matching. However, any methods or systems of facial recognition currently known or later developed may be used, as would be understood by those skilled in the art, given the benefit of this disclosure. In one embodiment, one or more of the facial recognition steps may be performed by the ADC 102 while the remaining steps may be performed remotely by the central server. For example, the facial recognition information obtained as the result of the detection step may be stored on the ADC 102 and transmitted to the central server for further processing. Performing some of the steps remotely may increase processing speeds of the facial recognition information and set aside more computational resources for other tasks performed by the ADC 102. Alternatively, all the steps of facial recognition may be performed by the ADC 102. Performing the facial recognition steps locally by the CPU 110 may provide facial recognition information faster than if the facial recognition is performed at a later time.

In one embodiment, the detection step obtains facial recognition information by identifying and extracting the image 114 of a person's face from the video footage obtained by the camera 106. In one example, the detection step may be performed by monitoring the environment for consumers walking past the ADC 102, while the camera 106 continuously records the scene. The CPU 110 may be configured to differentiate between a person's face and the rest of the background. As a result of detecting a person's face within the scene, the camera 106 may be directed to capture an image of the scene in addition to the video recording.

In another embodiment, the CPU 110 may be further configured to extract the image 114 of the person's face from the rest of the image. The image 114 may be a two-dimensional or a three-dimensional image. In one embodiment, the facial image 114 may be stored as facial recognition information. As described further below, the facial recognition information may be re-processed at a later time using various methods of facial recognition and image processing. In one example, the facial recognition information may be processed by the CPU 110 and transmitted to the central server. In another embodiment, the facial recognition information may be transmitted to the central server that is configured to receive, store and process the facial recognition information.

In one embodiment, the CPU 110 further analyzes the facial recognition information to detect an impression, which includes a determination of whether the person is looking at the display screen 104. According to one embodiment, the impression is detected by measuring the alignment of the head. However, other methods of detecting an impression can be used. The alignment of the head can be determined by measuring the X-Y (left/right and up/down) rotation of the head, as well as, the tilt of the head. The alignment of the head in relation to the display screen 104 may be indicative of a line of sight of the consumer. It is appreciated that the line of sight approximately directed at the display may indicate that the person is looking at the display screen 104. As the result of detecting the impression, the facial recognition information obtained from the camera 106 may be marked or recorded as an impression. The impression may then be stored in the local media storage 108 with the facial recognition information.

According to various embodiments, recording consumer impressions allows the advertiser to measure customer's interest in the advertisement or information displayed on the display screen 104. The quality or strength associated with the impression may further determine the degree of the customer's interest. In one embodiment, an angle of alignment of the head may indicate the strength of the impression. For example, if the head is aligned directly with display screen 104 (i.e. person is looking at the display), the impression may be stronger than if the head is partially turned to the display screen 104. In another embodiment, duration of the impression (i.e. the period of time the customer looks at the display screen 104) may be recorded. The duration may further indicate the strength of the impression. For example, a longer duration indicates that the impression is stronger, showing stronger interest in the advertisement or information.

Once the impression is detected, the camera 106 may continue to track the movement of the subject's face to determine whether repeat impressions are made. For example, a repeat impression is recorded as the result of the subject looking away from the display screen and then subsequently looking back at the display screen. A repeat impression during the duration of the same advertisement may indicate a weaker interest in the advertisement and therefore a weaker impression. Conversely, repeat impression for a similar advertisement subsequently shown on the display screen 104 may indicate the customer's increased interest in the subject matter of the advertisements and indicate a stronger impression.

In one example, a unique identification value or ID is generated for each identified impression and stored with the facial recognition information. The IDs and facial recognition information may form a database of impressions which may be stored on the local media storage 108. The stored information in the impression database may be transmitted to the central server. The facial recognition information may be transmitted in real time, soon after the information is stored on the local media storage 108 or periodically, for example, every 2 hours or at the end of a business day. In one example, the facial recognition information may be transmitted to the central server on demand.

In one embodiment, the impressions recorded in the impression database may be used to determine which advertisement interested the consumer by correlating the recorded impressions to the advertisement displayed on the display screen 104. The information may be stored in the impression database and used to generate impression statistics for each advertiser. The impression statistics along with the facial recognition information may allow the advertiser to learn more about the effects of the advertisements, as well as, the demographics of consumers viewing them. In one embodiment, the correlation of recorded impressions to the advertisements may strengthen the correlation between customer's interest and the subject matter of the advertisement. For example, if a person is attracted to the advertisement or information displayed on the display screen, the person turning away from the display screen 104 when the subsequent advertisement is shown indicates a stronger correlation between the impression and the content of the previously displayed advertisement.

Any methods or systems of correlating advertisements 112 to impressions may be used, as would be understood by those skilled in the art, given the benefit of this disclosure. The CPU 110 may collect information about the advertisements 112 shown on the display screen 104 and store that information on the local media storage 108. The CPU 110 may determine a display timestamp, which includes the starting time and duration for each advertisement shown on the display screen 104. The CPU 110 may also determine display times, or how many times a particular advertisement was shown on the display screen 104. Display times and display timestamp information may be stored on each ADC 102 and transmitted to the central server 302 (shown in FIG. 3) in real-time, for example, as soon as the advertisement is displayed. Alternatively, the information may be transmitted on a regular basis, for example, at the end of a business day or every 2 hours. In another example, the display information may be transmitted to the central server on demand from the central server.

In one embodiment, the CPU 110 correlates the advertisement 112 to the impression by using a real-time correlation method. Real-time correlation method may be performed as each impression is identified. As each impression is recorded, the CPU 110 may determine which advertisement 112 is displayed on the display screen 104. The impression may be associated with the displayed advertisement 112 and stored on the local media storage 108. Real-time correlation method may provide faster generated consumer statistical information for the advertisers. In another example, the central server receives both the impression information and the advertisement information and performs the correlation between the two using the real-time correlation method.

In another embodiment, the CPU 110 correlates the advertisement 112 to the recorded impression using a historic correlation method. The time associated with each advertisement 112 may be stored in local media storage 108, as described above. For each impression recorded, the CPU 110 may mark the period of time associated with the impression with a timestamp. The timestamp may identify the starting time and the duration of each impression. The CPU 110 may then match the timestamp of the impression with the timestamp stored for previously displayed advertisements. A match between the two timestamps indicates that the impression occurred while that particular advertisement was displayed. In another example, the central server receives both the impression information and the advertisement information and performs the correlation between the two using the historic method.

In one embodiment, the impression is linked with the matched advertisement by the CPU 110 and stored on the local media storage 108. The historic correlation method may be performed periodically on impressions previously stored in the local media storage 108. For example, historic correlation may be performed at the end of a business day for one or more of the impressions recorded during that day, and the correlated information may be transmitted to the central server. In another embodiment, the displayed advertising information and the impression information may be transmitted to the central server, where the historic correlation method may be performed. In either embodiment, the historic correlation method may conserve computational resources of the CPU 110, by performing the historic correlation method during times when more computational resources are available, such at during off-peak hours, such as when the commercial locations are closed.

In one embodiment, the steps of measurement, representation, and matching may be performed on the facial recognition information stored in the impression database by a recognition engine. In one example, the recognition engine may be part of the CPU 110 located on the ADC 102. In another example, the recognition engine may be located remotely, for example on the central server. In yet another example, the recognition engine may be provided by a third party. In this example, the facial recognition information may be transmitted to the third party and the resulting match may be received from the third party.

In one example, the recognition engine performs the step of measurement by measuring various facial features from the image or video footage. Facial features may include the relative position, size, or shape of eyes, nose, cheekbones, mouth, and jaw. In one embodiment, the recognition engine then performs the representation step by translating the measured data into a unique code, sometimes called a face print. The recognition engine may match the unique code or face print to a database of facial images. In one example, the database can be obtained from images recorded at one or more ADCs. In another example, the database can be obtained from outside sources, such as department of motor vehicles, social media, etc. The identity of the matched subject may be stored in the local media storage of the ADC or in memory of the central server and may be associated with the impression ID in the impression database.

As discussed above, the recognition engine may be located remotely and may perform the described functions on facial recognition information previously obtained in batches. Alternatively, the recognition engine may perform the described functions in real-time, as each facial image is acquired. Furthermore, more than one facial recognition method may be subsequently performed on the same extracted image. The extracted image may be further processed to better refine the image and the results achieved. For example, image enhancement techniques, local feature analysis, skin biometrics, line edge mapping or other processing techniques may be used. In addition, facial recognition information may then be subject to human review via a variety of mechanisms.

In one embodiment, the facial information may also be analyzed to obtain summary information about the person. In one embodiment, common emotions that are related to facial features can be detected from the facial information. For example, by analyzing the subject's mouth, eyes and/or cheek bones, one or more emotions may be detected, such as, whether the subject is happy, sad, angry, or interested. The features of the subject's face may be used to obtain demographic such as, age, race, and/or sex. This data can be obtained using various methods and can also be subject to human review via a variety of mechanisms. The summary information may be stored in the local media storage of the ADC or in memory of the central server and may be associated with the impression ID in the impression database.

In another embodiment, the facial information may used to detect and track repeat visitors to the advertising location. In one example, as each impression is detected, the impression database is searched for matching images and the impression record is updated as the result of the match. First, that record may be marked with the time and date of the repeat visit. Second, the facial recognition information associated with the record may also be updated with the most recently obtained image. Updating the image in the impression database may allow the system to keep track of changing facial features.

In another embodiment, the impression database may also be used to correlate sales transactions from point-of-sale terminals to the impression and the facial information obtained by the ADC 102. It is appreciated that by correlating the sales transactions to the impressions, the advertiser can determine whether the advertisements are having an impact on sales of specific products. In one example, the commercial locations use one or more point-of-sale terminals, such as cash registers, to process and record sales transactions between commercial locations and consumers. The sales information may be transmitted to the ADC 102 and stored in the local media storage 108. The sales transactions may be correlated to the impression statistics using the correlation methods described above. However, any methods of correlating sales transactions to impressions may be used, as would be understood by those skilled in the art, given the benefit of this disclosure.

The facial recognition information may further be used for security and law enforcement purposes. The video recording and the facial recognition information obtained using the camera 106 may be used in a system and method of video surveillance of a commercial location, such as, a convenience store. Furthermore, the facial recognition information could also be used to aid investigation of security incidents, for example, by obtaining identification information of potential suspects recorded using the camera 106. The facial recognition information may also be used to prevent identify theft and fraudulent transaction, for example, by confirming the identity of a credit card user.

The ADC 102 may include additional components such as the local media storage 108, the CPU 110, one or more peripheral devices, and communication components. The local media storage 108, included as part of the ADC 102, may include a computer readable and writeable nonvolatile non-transitory storage medium in which instructions are stored that define one or more programs to be executed by the CPU 110. For example, the programs may include a multimedia player designed to play or display the advertisement in multiple multimedia file formats utilized by the system. The medium may, for example, be optical disk, magnetic disk or flash memory, among others. However, local media storage 108 is not limited to a particular memory system or storage system.

The CPU 110 may comprise one or more processors, microprocessors or other types of controllers or microcontrollers, which can perform a series of instructions that result in manipulated data. The CPU 110 may be a commercially available processor such as an Intel Xeon, Itanium, Core, Celeron, Pentium, AMD Opteron, Sun UltraSPARC, IBM Power5+, or IBM mainframe chip, but may be any type of processor, multiprocessor or controller. As shown, the CPU 110 may be connected to other system elements, including the local media storage 108 and the display screen 104.

The ADC 102 may further include other computer components, such as memory that may be used for storing programs and data during operation of the ADC 102, communication bus or other internal communication system that may enable communications to be exchanged between system components of the ADC 102, and a communication device that allows communication between the ADC 102 and the central server 302. In one embodiment, the ADC 102 includes input and output ports that provide for a number of peripherals to be connected to the ADC 102. Examples include barcode scanners, mouse devices, trackballs, magnetic strip readers, microphones, touch screens, printing devices, speakers, etc.

The ADC 102 may include an operating system that manages at least a portion of the hardware elements included in ADC 102. A processor or controller, such as the CPU 110, may execute an operating system which may be, among others, a Windows-based operating system (for example, Windows XP, Windows Vista or Windows 7) available from the Microsoft Corporation, a MAC OS System X operating system available from Apple Computer, one of many Linux-based operating system distributions or a UNIX operating systems available from various sources. Many other operating systems may be used, and embodiments are not limited to any particular operating system.

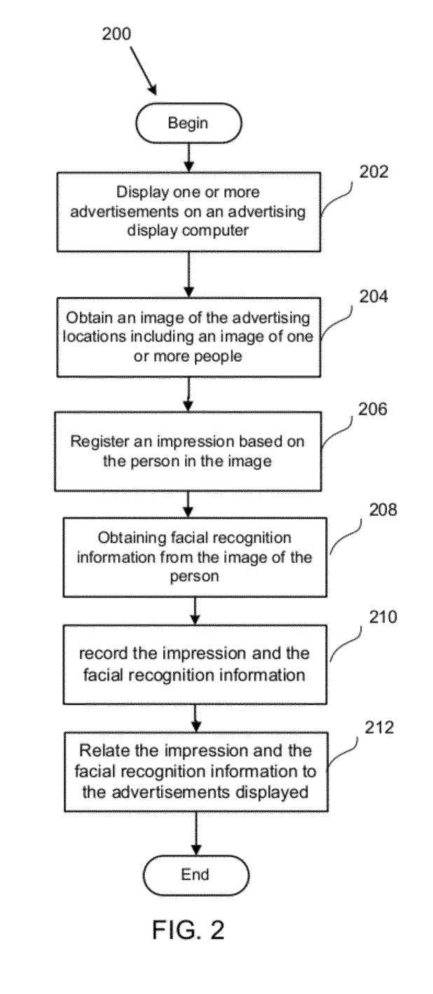

FIG. 2 shows an example of a method of displaying a plurality of advertisements, in which various aspects and functions according to aspects and embodiments of the present invention may be practiced. As illustrated, the method 200 includes displaying advertisements on the ADC (step 202). Obtaining an image of the advertising locations, the image includes one ore more people at the advertising location (step 204) and registering a consumer impression from the image (step 206). In one example, the consumer impression is determined from detecting whether a consumer is looking at the display. The image may be further analyzed and facial recognition information may be obtained from the image of the person (step 208). The detected impression along with the facial recognition information is recorded (step 210) and the impression and the facial recognition information are correlated to one or more of the advertisements displayed on the ADC (step 212).

FIG. 3 shows a central advertising system 300, in which various aspects and functions according to aspects and embodiments of the present invention may be practiced. For example, as illustrated, the system 300 includes a central server 302 which further includes a media scheduling server 304, a user interface 306, an impression database 308, a reporting engine 310, a customer database 312 and a media database 314. The central server 302 establishes a central location for remote storage of advertisements for multiple ADC locations, obtains and compiles statistics from multiple ADCs and allows remote access and control by multiple users.

The central server 302 may include the media scheduling server 304, which determines the advertising content and provides instructions to each ADC 102 for displaying that content. The advertiser creates the advertisement and transmits the advertisement to the central server 302 where the advertisement may be stored in the media database 314. The media scheduling server 304 may determine formatting information for the advertisement to be displayed on the ADC 102. The media scheduling server 304 may create a queue or line up 316 of advertisements for each ADC 102 at each commercial location.

The line-up 316 may include purchased advertisements for that particular location and may also include site-specific advertisements, which may be exclusive to the particular commercial location. Site-specific advertisements may be advertisements for goods or services sold on-site at the commercial location. In embodiments that include a convenience store, the site-specific advertisement might show weekly specials on specific goods sold in the store. The site-specific advertisements may be shown in exchange for placement of the ADC 102 in the commercial location. The line-up 316 may also include additional announcements comprising information of interest to the general public, such as, weather, news, local events, quotes or trivia.

The media scheduling server 304 distributes the purchased advertisements and the site-specific advertisements uniformly throughout the line-up 316 for a predetermined period of time; for example, for the duration of a day at the commercial location. Depending on the number of purchased advertisements and site-specific advertisements, the line-up may be supplemented with the additional announcements. Each advertisement or announcement is repeated at regular intervals throughout the predetermined period of time.

The user interface 306 may guide the advertisers though the process of uploading and purchasing advertising at available commercial locations. The user interface 306 may display physical addresses of ADCs and provides for the user to select one or more locations where advertising can be purchased. The user interface 306 may provide input screen which provides for the user to transmit advertisements onto the central server 302 to be stored in the media database 314. The user interface 306 may be programmed in one or more computer languages (e.g., an HTML, Java, Macromedia Flash, or other type interface).

One or more advertisers or commercial location owners may access the user interface 306 though a remote computer 318. In one example, the remote computer 318 renders a browser window by executing a browser program (e.g., the Internet Explorer browser program available from the Microsoft Corporation). The advertiser enters a URL address in a window of the browser interface, and is directed to a website associated with the central server 302. This website may be rendered by, for example, a WWW server process associated with central server 302. The remote computer 318 may be a general purpose computer. Alternatively, other ways of accessing the user interface may be used (e.g., mobile phone, smart phone, tablet computer, PDA, or other method).

The user interface 306 may provide for the advertiser to create a user account by inputting information about the advertiser, such as, contact information, billing information and account preferences. This information is stored in the customer database 312 and may be correlated with the advertisements stored in the media database 314. The advertiser may access one or more of the features of the user interface by entering a user identification and password associated with the advertiser's user account.

In one embodiment, the user interface 306 presents to one or more advertisers available commercial locations where one ore more ADCs are placed. The available ADCs may be displayed on an interactive map, which may be organized visually by geographical regions or areas. In one embodiment, the advertiser, through a series of successive selections in the user interface 306 is able to view the ADCs located in the desired geographical region. Alternatively, the user interface 306 may display the available ADCs in the form of a list. The advertiser may input a search, the user interface 306, for ADCs by entering an address or zip code. The advertiser may be able to select each commercial location and obtain more information about the location, for example, a description and contact information for the location, as well as demographic information about customers frequenting that particular location. In one embodiment, the advertiser may be able to select more than one ADC in the geographical area.

The central server 302 may obtain, store and process information from one or more ADCs placed at commercial locations. This information may be compiled into statistical information using various methods and displayed to advertisers and sales and marketing employees. The advertiser may use the compiled statistics to change the advertisements to better target specific demographics of consumers. The ADC provider may use the compiled statistics to change the line-up of advertisements. The commercial location owner may also use the compiled statistics to change the location of the ADC, add or change promotional items sold at the commercial location. The commercial location owner may further compare sales of promotional items against a baseline of non-promotional items to determine the impact of the advertisements.

The information stored on the local media storage 108, including the impression database and the advertisement records, may be transmitted to the central server 302 and stored in the impression database 308. The reporting engine 310, included in the central server 302, may store, compile, organize and display statistics based on advertisement display information received from the ADCs at each of the commercial locations. For example, information stored in the impression database 308 includes but is not limited to images, IDs, facial features, demographic information part of the impression database, as well as, display times and sales transaction information from the commercial locations. The information may be stored in each ADC 102 and transmitted to the central server periodically, for example, at the end of a business day. In one example, the information may be transmitted to the central server on demand from the central server. Alternatively, the information may be transmitted to the central server 302 in real time, as each time a record is made or updated.

The reporting engine 310 may be configurable to receive input from the user to select which combinations of statistics to combine and may visually present this information through a user interface. In one example, the compiled statistics are accessible by the advertiser as the information is updated. Alternatively, the statistics may be available after a pre-determined period of time, for example, a business day, week or month after the statistics are generated.

The ADC 102 may communicate with the central server 302 through a number of connectivity methods, protocols or standards and may include any communication network through which computer systems may exchange data. For example, Ethernet, including DSL, Cable DSL, LAN or WAN, Wi-Fi, WiMAX, Bluetooth, Mobile Broadband, including EVDO, 1X, 3G, 4G, Satellite based internet, or protocols such as, TCP/IP, PHP, HTTP, FTP, SNMP, SMS, MMS, or other protocols, either alone or in combination.

In one embodiment, the central server 302 may provide an interface to employees to access and manage the media database 314 and the customer database 312. The interface may provide different levels of limited access to employees with different levels of authorization. For example, the interface may provide sales employees access the customer database 312 to add new customers, while the interface may provide marketing employees access the media database to add and edit advertisements. The employees may access the respective databases through a remote computer 320. In one example, the remote computer 320 renders a browser window by executing a browser program (e.g., the Internet Explorer browser program available from the Microsoft Corporation). This browser window may render a website by, for example, a WWW server process associated with the central server 302. The remote computer 320 may be a general purpose computer. Alternatively, other ways of accessing the user interface may be used (e.g., mobile phone, smart phone, tablet computer, PDA, or other method).

The central server 302 may be a general-purpose computer system, or any other type of computer system capable of storing advertisements and user information, scheduling advertisements on one or more ADCs, providing a user interface, and performing other advertisement related functions. Further, it should be appreciated that various advertising functions may be performed by one or more server systems. Central server 302 generally includes a processor for executing server-based advertising functions. Central server 302 may also include a memory for storing data associated with advertising programs, as well as, one or more network interfaces that permit central server to communicate with one or more ADCs. Further, central server 302 may include one or more storage entities, including disks or other media for storing data, such as, advertising media, location information and customer information. Central server 302 may have any number or types of processors that execute an operating system and one or more application programs. In one embodiment, central server provides web server content to one or more advertisers for the purpose of accessing the user interface.

The central server 302 may be implemented using existing commercial products, such as, for example, Database Management Systems such as SQL Server available from Microsoft of Seattle Wash., Oracle Database from Oracle of Redwood Shores, Calif., and MySQL from Sun Microsystems of Santa Clara, Calif. or integration software such as WebSphere middleware from IBM of Armonk, N.Y.

Various aspects and functions described herein in accordance with the various embodiments of present invention may be implemented as hardware or software on one or more computer systems. There are many examples of computer systems currently in use that may be suitable for implementing various aspects of the present invention. Some examples include, among others, network appliances, personal computers, workstations, mainframes, networked clients, servers, media servers, application servers, database servers and web servers. Other examples of computer systems may include mobile computing devices, such as cellular phones and personal digital assistants, network equipment, devices involved in commerce such as bar code scanners and other devices. Additionally, aspects may be located on a single computer system or may be distributed among a plurality of computer systems connected to one or more communication networks.

Based on the foregoing disclosure, it should be apparent to one of ordinary skill in the art that the invention is not limited to a particular computer system platform, processor, operating system, network, or communication protocol. Also, it should be apparent that the present invention is not limited to a specific architecture or programming language.

Having now described some illustrative aspects of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

What is claimed is:

1. A computer-implemented method of obtaining consumer information from an advertising display computer (ADC) located at a plurality of advertising locations, the method comprising acts of:
displaying a plurality of advertisements on the ADC;
capturing at least one image at the plurality of advertising locations, the at least one image including an image of at least one person;
determining at least one impression from the image of at least one person;
detecting facial recognition information from the image associated with the at least one impression;
storing impression information and the facial recognition information associated with the at least one impression; and
associating the impression information and the facial recognition information with one of the plurality of advertisements displayed on the ADC.

2. The computer-implemented method of claim 1, wherein the act of determining the impression comprises determining whether the at least one person is looking at the advertising display computer.

3. The computer-implemented method of claim 1, wherein the act of detecting the facial information further comprises detecting a unique set of facial features of the at least one person.

4. The computer-implemented method of claim 1, wherein the act of detecting the facial information further comprises detecting at least one emotional expression of the at least one person.

5. The computer-implemented method of claim 1, wherein the act of detecting the facial information about the at least one person further comprises matching the facial recognition information of the at least one person to a database of facial recognition information.

6. The computer-implemented method of claim 1, wherein the act of determining at least one impression from the image of at least one person further comprises assigning an identification value to the at least impression.

7. The computer-implemented method of claim 1, further comprising producing facial recognition and impression statistics generated from the at least one impression and the facial information.

8. The computer-implemented method of claim 1, associating the at least one impression and the facial recognition information with one of the plurality of advertisements further comprises storing a first timestamp value for the plurality of advertisements, wherein the timestamp value includes a time associated with display of an advertisement on the ADC.

9. The computer-implemented method of claim 8, associating the at least one impression and the facial recognition information with one of the plurality of advertisements further comprises storing a second timestamp value for the at least one impression, wherein the timestamp value includes a time associated with a determination that the at least one person is looking at the ADC.

9. (canceled)

10. A system obtaining consumer information at a plurality of advertising locations, the system comprising:
an advertising display computer (ADC) located at the plurality of advertising locations configured to display at least one advertisement;
a camera disposed to capture at least one image of each of the plurality of advertising locations, the at least one image including an image of at least one person;
a processor configured to:
determine at least one impression from the image of at least one person,
detect facial information from the image associated with the at least one impression, and
associate the at least one advertisement displayed on the ADC with the at least one impression and the facial information; and
an impression database configured to store impression information and the facial information associated with the at least one impression.

11. The system of claim 10, wherein the at least one impression comprises detection of the at least one person looking at the at least one advertisement on the ADC.

12. The system of claim 10, wherein the impression database is configured to store an identification value for each impression based on the at least one person.

13. The system of claim 10, wherein the processor further includes a recognition engine adapted to determine at least one emotion associated with the at least one person.

14. The system of claim 10, wherein the processor is configured to record a timestamp value for the at least one advertisement displayed on the advertising display.

15. The system of claim 14, wherein the processor is configured to determine a timestamp value for the at least one impression.

16. The system of claim 15, wherein the processor is configured to associated the timestamp value for the at least one advertisement of with the timestamp value for the at least one impression.

17. A system obtaining consumer information at a plurality of advertising locations, the system comprising:
a media scheduling server configured to determine a schedule including at least one advertisement at an advertising display computer (ADC) at each of the plurality of advertising locations;
a communication device configured to transmit the at least one advertisement to the ADC and receive advertisement display information, impression information and facial recognition information associated with at least one impression from the ADC at each of the plurality of advertising locations;
a reporting engine configured to process the advertisement display information, the impression information and the facial recognition information; and
a user interface configured to display the processed advertisement display information, the impression information and the facial recognition information.

18. The system of claim 17, wherein the at least one impression comprises detection of the at least one person looking at the at least one advertisement on the ADC and the impression information comprises an identification value for the at least one impression associated with the at least one person.

19. The system of claim 17, wherein the processor is configured to:
determine a first timestamp value for the at least one advertisement displayed on the advertising display and a second timestamp value for the at least one impression; and
associate the first timestamp value with the second timestamp value.

20. (canceled)

21. The computer-implemented method of claim 9, further comprising the acts of: comparing the first timestamp value with the second timestamp value to associate the at least one impression, the impression information and the facial recognition information with the at least one advertisement.
